(19) United States
(12) Patent Application Publication
(10) Pub. No.: US 2008/0307497 A1
(43) Pub. Date: Dec. 11, 2008

(54) Method And System For Preventing Malicious Code From Being Introduced Into A Protected Network

(75) Inventor: Victor I. Sheymov, Vienna, VA (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: INVICTA NETWORKS, INC., Herndon, VA (US)

(21) Appl. No.: 11/792,080

(22) PCT Filed: Dec. 5, 2005
(86) PCT No.: PCT/US2005/044040

§ 371 Date: Apr. 2, 2008

Related U.S. Application Data
(60) Provisional application No. 60/633,176, filed on Dec. 6, 2004.

(51) Int. Cl. H04L 9/00; G06F 21/00

(52) U.S. Cl. 726/3; 726/24

(57) ABSTRACT

A method, system, and device for secure communications are provided, including at least one of means for configuring two or more computer devices as a single computer device; and means for separating the two or more computer devices from one or more computer networks.

### BACKGROUND OF THE INVENTION

1. Field of the Invention

The present invention generally relates to system and methods for protecting computer networks, and more particularly to a system and method for preventing malicious code from being introduced into a protected network.

2. Discussion of the Background

In recent years, a substantial number of computer cyber attacks are executed by introducing malicious code into a computer through a network connection and which can be activated at a later time (e.g., viruses, worms, etc.). One solution is to close the network and to make the connections to the network only available to authorized computers. Some organizations indeed close their networks, requiring a security protocol to be followed to connect to a computer on the network. While such degree of protection substantially varies, the owners of such networks often consider such networks to be “secure” networks.

However, as illustrated in FIG. 1, one of the problems facing such secured networks is a security threat posed by “dual use” computers, e.g., computers that can be used interchangeably inside and outside the secure network. Such a dual use computer successfully can be attacked by dual use the computer acquiring malicious code, for example, while being connected to an unsecured network, such as while browsing Internet, receiving outside e-mail, etc. If subsequently the same computer is connected to a secure network, the acquired malicious code can be introduced into the secure network. Virus protection mechanisms sometimes deployed within the computer or during the connection to the secure network are often inadequate to handle such a threat, due to their reactive nature and increasing sophistication of malicious code.

One solution for addressing the above problem is to completely close the secure network and exclude such “dual” connections for secure computers. For a variety of reasons, many organizations resist such measures. Furthermore, even if implemented by an organization, such separation is very difficult to enforce in cases of employees traveling with supposedly secure laptop or notebook computers authorized to connect to the secure network outside the control area of the organization, such as when an employee with a secure laptop computer of an organization connects to the Internet while in a hotel room. In this scenario, one simple Internet browsing session in the hotel room can end up with the introduction of malicious code into the secure computer and which then can be introduced into the closed network of the organizational during the next secure session connection with the closed network, even with the most sophisticated security mechanism deployed during such connection.

### SUMMARY OF THE INVENTION

Therefore, there is a need for a method, system, and device that address the above and other problems with network security systems, and methods. The above and other needs are addressed by the exemplary embodiments of the present invention, which provide a method, system, and device for secure communications. The exemplary embodiments include a computer, such as a laptop, a notebook, a PC, etc., with a possible dual use or dual connections, configured as two or more computers, including an “internal” or “secure” computer, and an “external” or “insecure” computer, and which can be separated to varying degrees. For example, the internal or secure computer can be configured to connect to a corresponding secure network or networks through the Internet or otherwise, while the external or insecure computer can be configured to connect to the Internet with fewer restrictions or without any restrictions at all, as compared to the internal or secure computer. Advantageously, malicious code introduced into the external or insecure computer can be prevented from being introduced into the secure network, wherein damage caused by the malicious code can be limited to the external or insecure computer.

Accordingly, in exemplary aspects of the present invention, a method, system, and device for secure communications are provided, including at least one of means for configuring two or more computer devices as a single computer device; and means for separating the two or more computer devices from one or more computer networks.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates a dual use computer for describing the exemplary embodiments; and

FIG. 2 illustrates an exemplary secure communications system for addressing problems with dual use computers.

### DETAILED DESCRIPTION OF THE PREFERRED EMBODIMENTS

An improved method, system, and device for secure communications are described. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

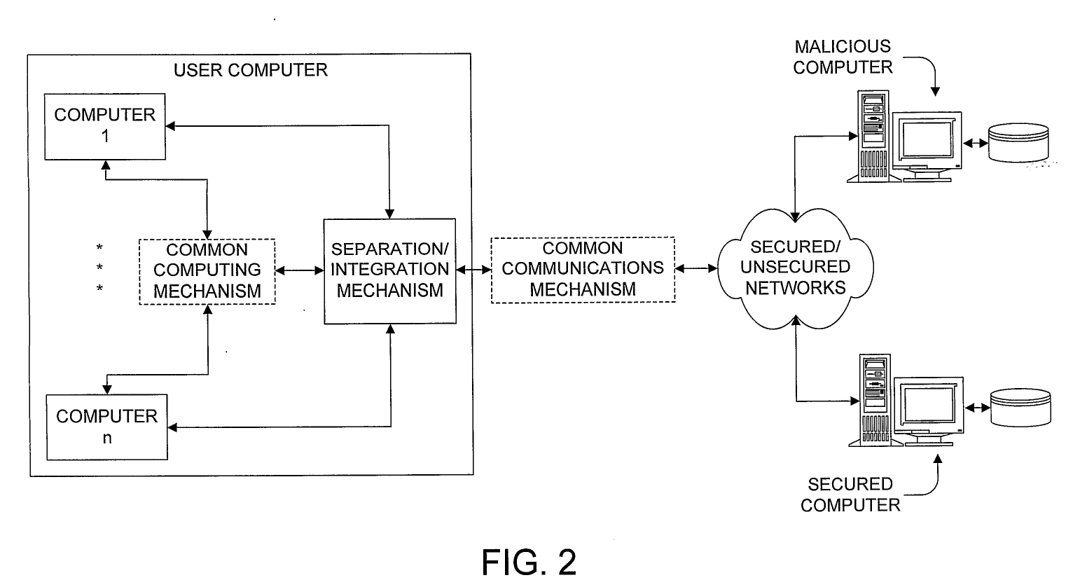

Referring now to the drawings, FIG. 2 thereof illustrates an exemplary secure communications for addressing problems with dual use computers. In FIG. 2, a user computer, such as a laptop, a notebook, a PC, etc., with a possible dual use or dual connections, can be configured as two or more computers (1 . . . n), including an “internal” or “secure” computer, and an “external” or “insecure” computer, and which can be separated by a separation or integration mechanism (e.g., implemented in software and/or hardware) to varying degrees. For example, the separation or integration mechanism can be configured to allow the internal or secure computer to connect to a corresponding secure network or networks through the Internet or otherwise, and to allow the external or insecure computer to connect to the Internet with fewer restrictions or without any restrictions at all, as compared to the internal or secure computer. Advantageously, malicious code introduced into the external or insecure computer can be prevented from being introduced into the secure network, wherein damage caused by the malicious code can be limited to the external or insecure computer.

In an exemplary embodiment, the separation or integration mechanism can include optional common computing mechanisms (e.g., BIOS, OS, memory, etc.) shared between the secure and insecure computers, optional common communications mechanisms (e.g., hardware and/or software ports, communications devices, modems, etc.) shared between secure and insecure computers, and the like. Accordingly, the degree of separation provided by the separation or integration mechanism to the secure and insecure computers can vary, for example, depending on preferences of the user computer manufacturer, preferences of the user, and the like. For example, in a case of fall separation, the separation or integration mechanism can include two separate computers sharing a common display and keyboard, with a manual switch for switching between the secure and insecure computer for respectively connecting to a secure and insecure network. In exemplary embodiments, the user computer combining the secure and insecure computers can be configured to have respective processors, a dual processor arrangement, and the like.

In further exemplary embodiments, a single processor can be employed, while the secure and insecure computers can be separated in various ways. For example, the secure and insecure computers can be configured to share a Basic Input Output System (BIOS), while having different or similar operating systems (e.g., Windows, Linux, and/or Macintosh OS, etc). In still further exemplary embodiments, the secure and insecure computers can be configured to share a hardware communications port, and the like. The separation or integration mechanism can be configured for switching from the secure computer to the insecure computer, and visa versa, and for example, can be implemented with hardware and/or software switching mechanisms, and the like. In an exemplary embodiment, communications mechanisms of the secure computer can be restricted only to communications to one or more designated networks.

With the exemplary separation or integration mechanisms, the combined secure and insecure computers can include respective communications restrictions. In further exemplary embodiments, such a combination can include more than two computers with respective restrictions on their communications. Such restrictions can be achieved through software and/or hardware, for example, by mechanical or other differentiation in ports used for communications connections, and the like.

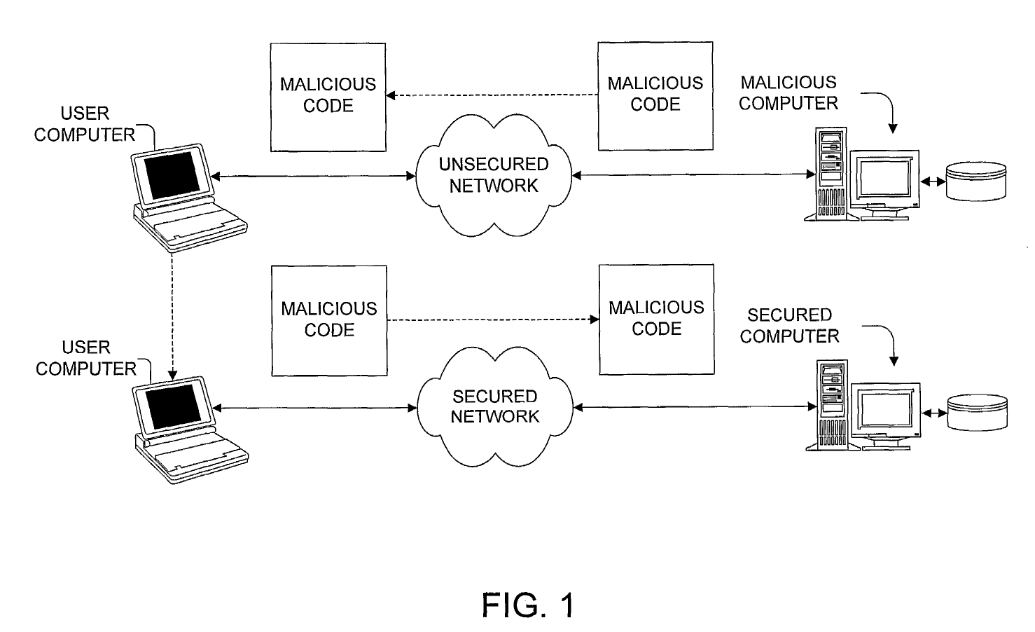

The above-described devices and subsystems of the exemplary embodiments of FIGS. 1-2 can include, for example, any suitable servers, workstations, PCs, laptop computers, PDAs, Internet appliances, handheld devices, cellular telephones, wireless devices, other devices, and the like, capable of performing the processes of the exemplary embodiments of FIGS. 1-2. The devices and subsystems of the exemplary embodiments of FIGS. 1-2 can communicate with each other using any suitable protocol and can be implemented using one or more programmed computer systems or devices.

One or more interface mechanisms can be used with the exemplary embodiments of FIGS. 1-2, including, for example, Internet access, telecommunications in any suitable form (e.g., voice, modem, and the like), wireless communications media, and the like. For example, the employed communications networks can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments of FIGS. 1-2 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-2 can be implemented via one or more programmed computer systems or devices.

To implement such variations as well as other variations, a single computer system can be programmed to perform the special purpose functions of one or more of the devices and subsystems of the exemplary embodiments of FIGS. 1-2. On the other hand, two or more programmed computer systems or devices can be substituted for any one of the devices and subsystems of the exemplary embodiments of FIGS. 1-2. Accordingly, principles and advantages of distributed processing, such as redundancy, replication, and the like, also can be implemented, as desired, to increase the robustness and performance the devices and subsystems of the exemplary embodiments of FIGS. 1-2.

The devices and subsystems of the exemplary embodiments of FIGS. 1-2 can store information relating to various processes described herein. This information can be stored in one or more memories, such as a hard disk, optical disk, magneto-optical disk, RAM, and the like, of the devices and subsystems of the exemplary embodiments of FIGS. 1-2. One or more databases of the devices and subsystems of the exemplary embodiments of FIGS. 1-2 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-2 can include appropriate data structures for storing data collected and/or generated by the processes of the devices and subsystems of the exemplary embodiments of FIGS. 1-2 in one or more databases thereof.

All or a portion of the devices and subsystems of the exemplary embodiments of FIGS. 1-2 can be conveniently implemented using one or more general purpose computer systems, microprocessors, digital signal processors, microcontrollers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-2 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-2, for driving the devices and subsystems of the exemplary embodiments of FIGS. 1-2, for enabling the devices and subsystems of the exemplary embodiments of FIGS. 1-2 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-2. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-2 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited, but rather covers various modifications and equivalent arrangements, which fall within the purview of the appended claims.

1-5. (canceled)

6. A secure communications system, the system comprising:
a communications device having dual use or dual communications connections capabilities and configured as two or more communications devices, including a secure communications device, and an insecure communications device; and
a separation or integration mechanism configured to separate or integrate the secure communications device and the insecure communications device,
wherein the separation or integration mechanism is configured to allow the secure communications device to connect to a secure network, and to allow the insecure communications device to connect to an unsecure network and with fewer restrictions or without any restrictions at all, as compared to the secure communications device.

7. The system of claim 6, wherein the communications device is mobile communications device, a laptop computer, a notebook computer, or a personal computer.

8. The system of claim 6, wherein the separation or integration mechanism is implemented in software and/or hardware.

9. The system of claim 6, wherein the secure communications device connects to the secure network through the Internet.

10. The system of claim 6, wherein the insecure communications device connects to the unsecure network through the Internet.

11. The system of claim 6, whereby malicious code introduced into the insecure communications device is prevented from being introduced into the secure network, and
wherein damage caused by the malicious code is limited to the insecure communications device.

12. The system of claim 6, wherein the separation or integration mechanism includes common computing mechanisms, including a basic input output system (BIOS), an operating system (OS), and/or a memory shared between the secure and insecure communications devices.

13. The system of claim 6, wherein the separation or integration mechanism includes common communications mechanisms, including hardware and/or software ports, communications devices, and/or modems, shared between the secure and insecure communications devices.

14. The system of claim 6, wherein the separation or integration mechanism provides a degree of separation to the secure and insecure communications devices depending on preferences of the communications device manufacturer, and/or preferences of the user.

15. The system of claim 6, wherein the separation or integration mechanism includes two separate communications devices sharing a common display and keyboard and with a switch for switching between the secure and insecure communications device for respectively connecting to the secure and unsecure networks.

16. The system of claim 6, wherein the separation or integration mechanism includes respective processors, including a dual processor arrangement for the secure and insecure communications devices.

17. The system of claim 6, wherein the separation or integration mechanism includes a single processor shared between the secure and insecure communications devices.

18. The system of claim 17, wherein the separation or integration mechanism includes the secure and insecure communications devices sharing a basic input output system (BIOS), while having a different or similar operating system (OS).

19. The system of claim 6, wherein the separation or integration mechanism includes the secure and insecure communications devices sharing a hardware communications port.

20. The system of claim 6, wherein the separation or integration mechanism switches from the secure communications device to the insecure communications device, and visa versa, via a hardware and/or software switching mechanism.

21. The system of claim 6, wherein the separation or integration mechanism includes communications mechanisms of the secure communications device restricted only to communications to one or more designated networks.

22. The system of claim 6, wherein the separation or integration mechanism includes the secure and insecure communications devices having respective communications restrictions through software and/or hardware, including by mechanical or differentiation ports used for communications connections.

23. The system of claim 6, wherein the separation or integration mechanism includes more than two communications devices with respective restrictions on communications thereof through software and/or hardware, including by mechanical or other differentiation ports used for communications connections.

24. A secure communications method, the method comprising:
configuring a communications device with dual use or dual communications connections capabilities and as two or more communications devices, including a secure communications device, and an insecure communications device;
separating or integrating the secure communications device and the insecure communications device via a separation or integration mechanism; and
allowing via the separation or integration mechanism the secure communications device to connect to a secure network, and the insecure communications device to connect to an unsecure network and with fewer restrictions or without any restrictions at all, as compared to the secure communications device.

25. The method of claim 24, wherein the communications device is mobile communications device, a laptop computer, a notebook computer, or a personal computer.

26. The method of claim 24, wherein the separation or integration mechanism is implemented in software and/or hardware.

27. The method of claim 24, wherein the secure communications device connects to the secure network through the Internet.

28. The method of claim 24, wherein the insecure communications device connects to the unsecure network through the Internet.

29. The method of claim 24, whereby malicious code introduced into the insecure communications device is prevented from being introduced into the secure network, and
wherein damage caused by the malicious code is limited to the insecure communications device.

30. The method of claim 24, wherein the separation or integration mechanism includes common computing mechanisms, including a basic input output system (BIOS), an operating system (OS), and/or a memory shared between the secure and insecure communications devices.

31. The method of claim 24, wherein the separation or integration mechanism includes common communications mechanisms, including hardware and/or software ports, communications devices, and/or modems, shared between the secure and insecure communications devices.

32. The method of claim 24, wherein the separation or integration mechanism provides a degree of separation to the secure and insecure communications devices depending on preferences of the communications device manufacturer, and/or preferences of the user.

33. The method of claim 24, wherein the separation or integration mechanism includes two separate communications devices sharing a common display and keyboard and with a switch for switching between the secure and insecure communications device for respectively connecting to the secure and unsecure networks.

34. The method of claim 24, wherein the separation or integration mechanism includes respective processors, including a dual processor arrangement for the secure and insecure communications devices.

35. The method of claim 24, wherein the separation or integration mechanism includes a single processor shared between the secure and insecure communications devices.

36. The method of claim 35, wherein the separation or integration mechanism includes the secure and insecure communications devices sharing a basic input output system (BIOS), while having a different or similar operating system (OS).

37. The method of claim 24, wherein the separation or integration mechanism includes the secure and insecure communications devices sharing a hardware communications port.

38. The method of claim 24, wherein the separation or integration mechanism switches from the secure communications device to the insecure communications device, and visa versa, via a hardware and/or software switching mechanism.

39. The method of claim 24, wherein the separation or integration mechanism includes communications mechanisms of the secure communications device restricted only to communications to one or more designated networks.

40. The method of claim 24, wherein the separation or integration mechanism includes the secure and insecure communications devices having respective communications restrictions through software and/or hardware, including by mechanical or differentiation ports used for communications connections.

41. The method of claim 24, wherein the separation or integration mechanism includes more than two communications devices with respective restrictions on communications thereof through software and/or hardware, including by mechanical or other differentiation ports used for communications connections.

42. A computer program product for secure communications, including one or more computer readable instructions embedded on a computer readable medium and configured to cause one or more computer processors to perform the steps of:
configuring a communications device with dual use or dual communications connections capabilities and as two or more communications devices, including a secure communications device, and an insecure communications device;
separating or integrating the secure communications device and the insecure communications device via a separation or integration mechanism; and
allowing via the separation or integration mechanism the secure communications device to connect to a secure network, and the insecure communications device to connect to an unsecure network and with fewer restrictions or without any restrictions at all, as compared to the secure communications device.

43. The computer program product of claim 42, wherein the communications device is mobile communications device, a laptop computer, a notebook computer, or a personal computer.

44. The computer program product of claim 42, wherein the separation or integration mechanism is implemented in software and/or hardware.

45. The computer program product of claim 42, wherein the secure communications device connects to the secure network through the Internet.

46. The computer program product of claim 42, wherein the insecure communications device connects to the unsecure network through the Internet.

47. The computer program product of claim 42, whereby malicious code introduced into the insecure communications device is prevented from being introduced into the secure network, and
wherein damage caused by the malicious code is limited to the insecure communications device.

48. The computer program product of claim 42, wherein the separation or integration mechanism includes common computing mechanisms, including a basic input output system (BIOS), an operating system (OS), and/or a memory shared between the secure and insecure communications devices.

49. The computer program product of claim 42, wherein the separation or integration mechanism includes common communications mechanisms, including hardware and/or software ports, communications devices, and/or modems, shared between the secure and insecure communications devices.

50. The computer program product of claim 42, wherein the separation or integration mechanism provides a degree of separation to the secure and insecure communications devices depending on preferences of the communications device manufacturer, and/or preferences of the user.

51. The computer program product of claim 42, wherein the separation or integration mechanism includes two separate communications devices sharing a common display and keyboard and with a switch for switching between the secure and insecure communications device for respectively connecting to the secure and unsecure networks.

52. The computer program product of claim 42, wherein the separation or integration mechanism includes respective processors, including a dual processor arrangement for the secure and insecure communications devices.

53. The computer program product of claim 42, wherein the separation or integration mechanism includes a single processor shared between the secure and insecure communications devices.

54. The computer program product of claim 53, wherein the separation or integration mechanism includes the secure and insecure communications devices sharing a basic input output system (BIOS), while having a different or similar operating system (OS).

55. The computer program product of claim 42, wherein the separation or integration mechanism includes the secure and insecure communications devices sharing a hardware communications port.

56. The computer program product of claim 42, wherein the separation or integration mechanism switches from the secure communications device to the insecure communications device, and visa versa, via a hardware and/or software switching mechanism.

57. The computer program product of claim 42, wherein the separation or integration mechanism includes communications mechanisms of the secure communications device restricted only to communications to one or more designated networks.

58. The computer program product of claim 42, wherein the separation or integration mechanism includes the secure and insecure communications devices having respective communications restrictions through software and/or hardware, including by mechanical or differentiation ports used for communications connections.

59. The computer program product of claim 42, wherein the separation or integration mechanism includes more than two communications devices with respective restrictions on communications thereof through software and/or hardware, including by mechanical or other differentiation ports used for communications connections.
